(19) United States
(12) Patent Application Publication
(10) Pub. No.: US 2024/0123582 A1
(43) Pub. Date: Apr. 18, 2024

(54) DOUBLE-ENDED QUICK-CHANGE TOOL BIT HOLDER ASSEMBLY AND QUICK-CHANGE BIT DRIVER MODIFICATION

(71) Applicant: James B. Marson, Elmwood, WI (US)

(72) Inventor: James B. Marson, Elmwood, WI (US)

(21) Appl. No.: 18/046,579

(22) Filed: Oct. 14, 2022

(51) Int. Cl. B25B 23/00

(52) U.S. Cl. CPC B25B 23/0035

(57) ABSTRACT

A double-ended quick-change tool bit holder assembly having a shaft with a first tool bit socket at a first end and a second tool bit socket at a second end, each of the first and second tool bit sockets configured to receive a tool bit. A first locking member is disposed over the first end of the shaft. A second locking member is disposed over the second end of the shaft. Each of the first and second locking members being movable between a release position and a lock position for releasably securing the tool bits in the respective first and second tool bit sockets. A collar may be disposed on the shaft. The collar may have an identifier on an exterior surface thereof. The double-ended quick-change tool bit holder assembly may be assembled from two OEM quick-change bit drivers connected end-to-end after removing the driver shanks therefrom.

### BACKGROUND

Quick-change bit drivers adapted for receiving interchangeable drivers bits for various types of threaded fasteners and for reversible drill/drivers (collectively “tool bits”) are well known in the art, and while quick-change bit drivers serve their intended purpose, all commercially available quick-change bit drivers have only one end in which the various tool bits can be inserted because the other end of the quick-change bit driver has a hex shaped drive shank fixed thereto which is received into the chuck of a power tool, such as a drill or impact driver. Most commercially available quick-change bit drivers are available with hex shaped drive shanks of different lengths, but if a consumer already owns a quick-change bit driver with a certain length drive shank (e.g., a three inch drive shank), but the consumer needs a quick-change bit driver with a shorter or longer drive shank for a particular job (e.g., 1.5 inch or six inch drive shank), the consumer must purchase a second quick-change bit driver with the desired length of the drive shank. It can be expensive to purchase multiple quick-change bit drivers having different length drive shanks. Accordingly, there is a need for a double-ended quick-change tool bit holder assembly that permits the interchangeability of any length of drive shank at one end while also permitting the interchangeability of different tool bits at the other end.

Furthermore, the locking member or mechanism on many commercially available quick-change bit drivers are prone to inadvertently release the tool bits if the locking mechanism catches on an object, such as frequently occurs when pulling the drill or power tool with a quick-change bit driver from a toolbelt. The invention by James B. Marson as disclosed in U.S. Pat. No. 8,607,673 (“the '673 patent”) provides a simple yet effective solution to prevent the inadvertent release of tool bits that plaque commercially available quick-change bit drivers. While the invention disclosed in the '673 patent serves its intended purpose, improvements can be made to provide additional features and functionalities.

### BRIEF DESCRIPTION OF THE DRAWINGS

FIG. 1A is an exploded perspective view of a commercially available quick-change bit driver for a reversible drill/driver tool.

FIG. 1B is a perspective view of the quick-change bit driver of FIG. 1A shown with the reversible drill/driver tool received in the socket and showing the locking member in the locked position.

FIG. 1C is an enlarged partial cross-sectional view of the quick-change bit driver of FIG. 1B shown with the locking member in the release position.

FIG. 1D is the same view as FIG. 1C, but showing the locking member in the locked position.

FIG. 2A is a perspective view of another commercially available quick-change bit driver.

FIG. 2B is a perspective view of the quick-change bit driver of FIG. 2A shown with a tool bit received in the quick-change tool driver socket and showing the locking member in the locked position.

FIG. 2C is an enlarged partial cross-sectional view of the quick-change bit driver of FIG. 2A shown with the locking member in the release position.

FIG. 2D is the same view as FIG. 2C, but showing the locking member in the locked position.

FIG. 3A is a perspective view of another commercially available quick-change bit driver.

FIG. 3B is a perspective view of the quick-change tool driver of FIG. 3A shown with a tool bit received in the quick-change bit driver socket and showing the locking member in the locked position.

FIG. 3C is an enlarged partial cross-sectional view of the quick-change bit driver of FIG. 3A shown with the locking member in the release position.

FIG. 3D is the same view as FIG. 3C, but showing the locking member in the locked position.

FIG. 4A is a perspective view of another commercially available quick-change bit driver.

FIG. 4B is a perspective view of the quick-change bit driver of FIG. 4A in the locked position.

FIG. 5 shows perspective views of the commercially available quick-change reversible drill/driver of FIGS. 1A-1B with a different length shanks.

FIG. 6 shows perspective views showing the commercially available quick-change bit driver of FIG. 3A with different length shanks.

FIG. 7 is a perspective view showing commercially available quick-change bit drivers corresponding to FIGS. 2A, 3A and 4A and showing commercially available tool bits having different length shanks.

FIG. 8A is an exploded perspective view showing the components of one embodiment of a double-ended quick-change tool bit holder assembly for reversible drill/driver tools.

FIG. 8B is a perspective view showing the assembled double-ended quick-change tool bit holder assembly of FIG. 8A and showing two spaced collars on the shaft between the locking members.

FIG. 8C is an enlarged partial cross-sectional view of the double-ended quick-change tool bit holder assembly of FIG. 8B showing the locking members at each end of the shaft in the release position relative to the collar.

FIG. 8D is the same view as FIG. 8C, but showing the locking members at each end of the shaft in the lock position relative to the collar.

FIGS. 9A-9D corresponding views of the double-ended quick-change tool bit holder assembly shown in FIGS. 8A-8D, but instead of two spaced collars, a single elongated collar is disposed on the shaft between the locking members.

FIG. 10A is an exploded perspective view showing another embodiment of a double-ended quick-change tool bit holder assembly in one form of assembly comprising two quick-change bit drivers as shown in FIG. 2A-2D with the drive shanks removed so the shafts can be connected together end-to-end forming one assembly and showing a collar disposed on the shafts between the locking members.

FIG. 10B is an exploded perspective view showing the double-ended quick-change tool bit holder assembly similar to FIG. 10A, but in another form of assembly.

FIG. 10C is a perspective view showing the assembled double-ended quick-change tool bit holder assembly of FIG. 10A or 10B and showing the collar installed on the shaft between the locking members, and showing the various tool bits receivable at either end.

FIG. 11A is an exploded perspective view showing another embodiment of a double-ended quick-change tool bit holder assembly in one form of assembly comprising two quick-change bit drivers as shown in FIG. 3A-3D with the drive shanks removed so the shafts can be connected together end-to-end forming one assembly and showing a collar disposed on the shafts between the locking members.

FIG. 11B is an exploded perspective view showing the double-ended quick-change tool bit holder assembly similar to FIG. 11A, but in another form of assembly.

FIG. 11C is a perspective view showing the assembled double-ended quick-change tool bit holder assembly of FIG. 11A or 11B and showing the collar installed on the shaft between the locking members, and showing the various tool bits receivable at either end.

FIG. 12A is an exploded perspective view showing another embodiment of a double-ended quick-change tool bit holder assembly in one form of assembly comprising two quick-change bit drivers as shown in FIG. 4A-4B with the drive shanks removed so the shafts can be connected together end-to-end forming one assembly and showing a collar disposed on the shafts between the locking members.

FIG. 12B is an exploded perspective view showing the double-ended quick-change tool bit holder assembly similar to FIG. 12A, but in another form of assembly.

FIG. 12C is a perspective view showing the assembled double-ended quick-change tool bit holder assembly of FIG. 12A or 12B and showing the collar installed on the shaft between the locking members, and showing the various tool bits receivable at either end.

FIGS. 13A-13D illustrate different quick-change bit drivers with an elongated collar disposed on the shafts thereof and wherein an exterior surface of the elongated collar includes an identifier.

FIGS. 14A-14C illustrate different embodiments of the collar that may be disposed on the double-ended quick-change tool bit holder assembly or a quick-change bit driver.

### DESCRIPTION

As used herein, the term “driver bit” is intended to refer to or encompass any type of driver tool used for driving threaded fasteners, including but not limited to, slotted/standard head fasteners, crosshead/Philips® head, star/Torx® head, hex/Allen® head, and square head fasteners, as well as any socket driver for receiving the head of any threaded fastener. Also as used herein, the term “quick-change bit driver” is intended to refer to or encompass any type of attachment that has a shank at one end that is adapted to be received in the chuck of a power tool (e.g., a drill or impact driver) and which has a socket at its other end for interchangeably receiving driver bits or reversible drill/drivers (discussed below) and which includes a locking mechanism or locking member to releasably retain the driver bit or reversible drill/driver tool within the socket.

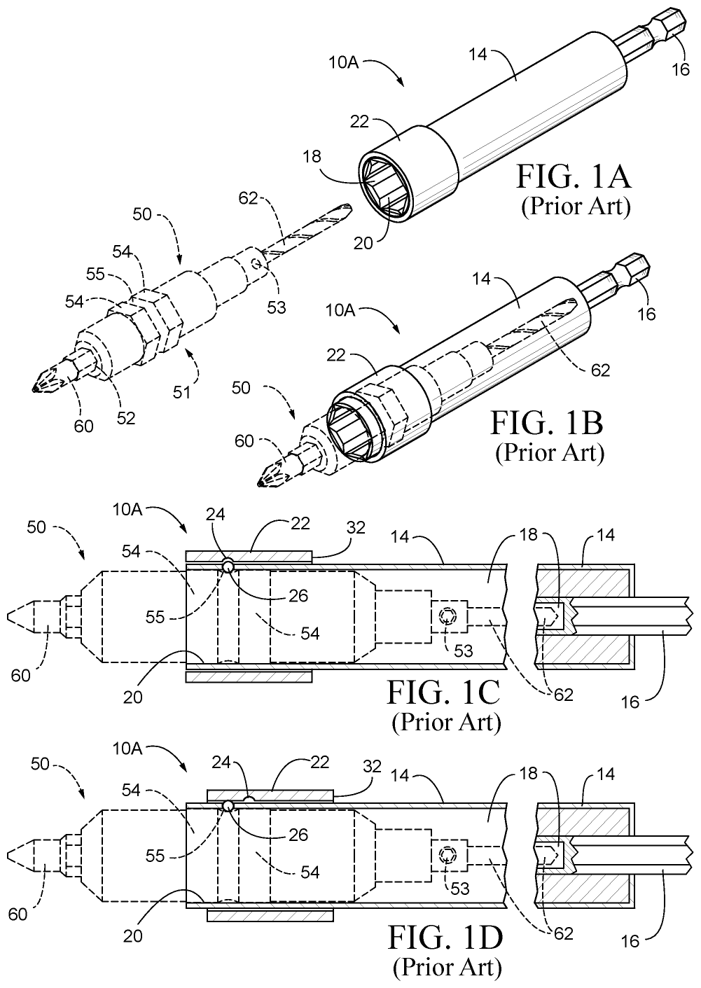

Referring now to the drawings, wherein like reference numerals designate identical or corresponding parts throughout the several views, FIG. 1 illustrates one embodiment of a commercially available quick-change bit driver 10A for a reversible drill/driver tool 50 such as manufactured by Jore Corporation and sold under the brand names Jore® and Montana®, and as disclosed in U.S. Pat. No. 6,176,654, incorporated herein in its entirety by reference. The drill/driver tool 50 includes a driver bit 60 at one end and a drill bit 62 at its other end. The quick-change bit driver 10A securely holds the drill/driver tool 50 but permits it to be quickly swapped or reversed end-for-end so that the user may easily switch between the drill bit 62 and the driver bit 60 as needed.

The drill/driver tool 50 includes a tool body 51 having a driver bit socket 52 at one end configured to receive complimentary interchangeable driver bits 60. The driver bits 60 may be magnet such that they are magnetically held within the driver bit socket 52. At its other end, the tool body 51 is configured to receive drill bits 62. The drill bits 62 are removably attached to the tool body 51, by a threaded fastener 53 such that different diameter drill bits 62 may be interchangeably attached to the tool body 51. The tool body 51 typically includes hex-shaped shoulders 54 separated by a circumferential depression 55, the purposes of which are discussed below.

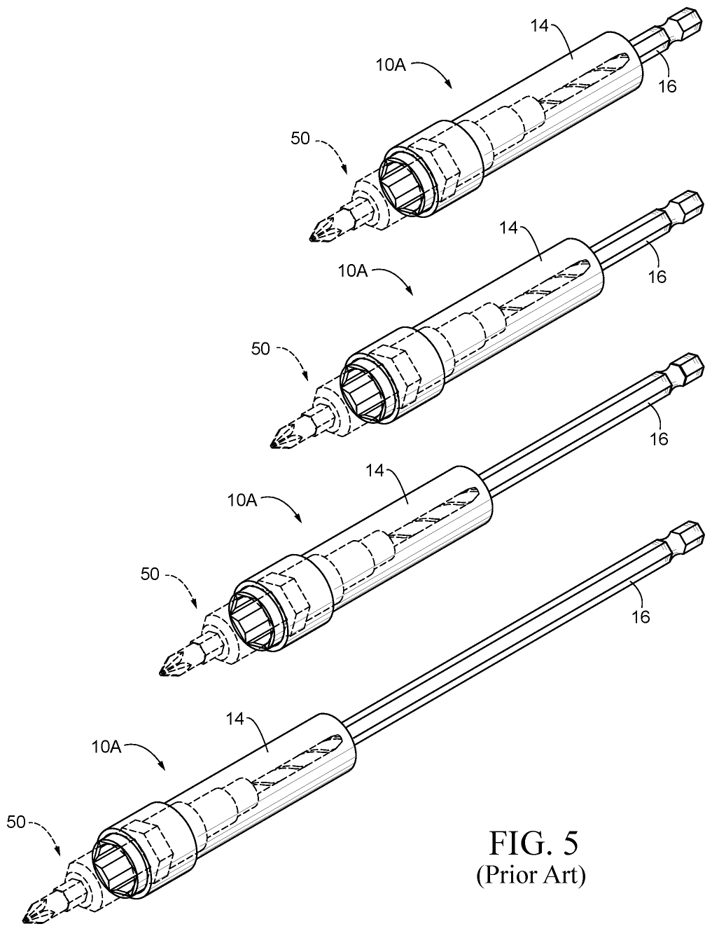

The quick-change bit driver 10A includes a shaft 14 having a hex shaped drive shank 16 fixed at one end. In use, the distal end of the drive shank 16 is received by a chuck of a power tool, such as a drill or impact driver (not shown). As represented by FIG. 5, the quick-change bit driver 10A may have different length drive shanks 16 fixed to the shaft 14. A countersunk central bore 18 extends into the shaft 14 to a depth to receive the drill bit 62. The countersunk bore 18 may extend into the end of the drive shank 16 fixed to the end of the shaft 14 as illustrated in FIGS. 1C and 1D in order to reduce the overall length of the quick-change bit driver 10A. The end of the central bore 18 opposite the drive shank 16 includes a hex shaped socket 20 to receive the hex shaped shoulders 54 of the drill/driver tool 50. The hex shaped socket 20 and the hex shaped shoulders 54 cooperate to prevent the reversible drill/driver tool 50 from rotating within the quick-change bit driver 10A.

The quick-change bit driver 10A includes a locking member 22 in the form of a sleeve which is movable fore and aft with respect to the shaft 14 between a release position (FIGS. 1A and 1C) and a lock position (FIGS. 1B and 1D). As best illustrated in FIG. 1C, in the release position, the locking member 22 is moved forwardly with respect to the shaft 14. In this position, a recess 24 in the interior of the locking member 24 aligns with a detent ball 26. When the drill/driver tool 50 is inserted into the socket 20, the detent ball 26 is forced radially outwardly into the recess 24 by the hex shaped shoulders 54 of the drill/driver tool 50. When the shoulders 54 are fully seated in the socket 20, the detent ball 26 drops into the circumferential depression 55 between the hex shaped shoulders 54. As shown in FIG. 1D, when the locking member 22 is moved rearwardly to the lock position, the detent ball 26 is held by the locking member 22 within the circumferential depression 55, thus locking the drill/driver tool 50 within the socket 20. To remove the drill/driver tool 50, the locking member 22 is moved to the release position, permitting the detent ball 26 to again move into the recess 24 such that the drill/driver tool 50 can be removed from the socket 20. The drill/driver tool 50 may be rotated end-for-end and then reinserted into the socket 20 and locked in place by again moving the locking member 22 to the lock position as previously described.

The above description is but one non-limiting example of a commercially available quick-change bit driver for reversible drill/driver tools. There are several other commercially available quick-change bit drivers for reversible drill/driver tools by other original equipment manufacturers (OEMs) and as disclosed in U.S. Pat. Nos. 6,347,914; 6,488,452; 6,761,361, each of which is incorporated herein in their entireties.

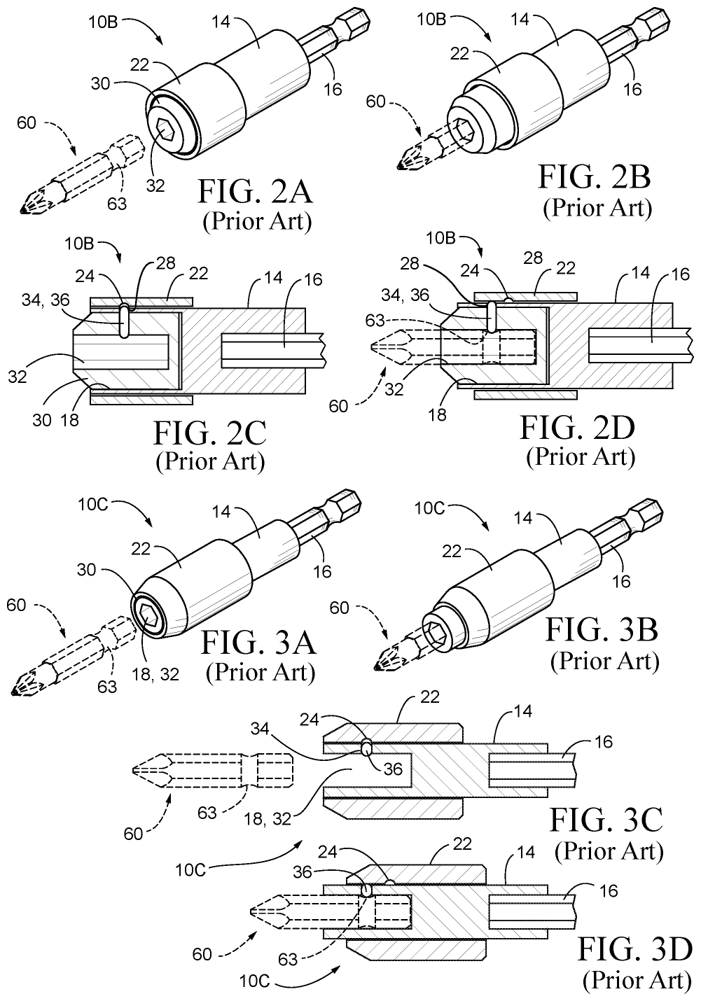

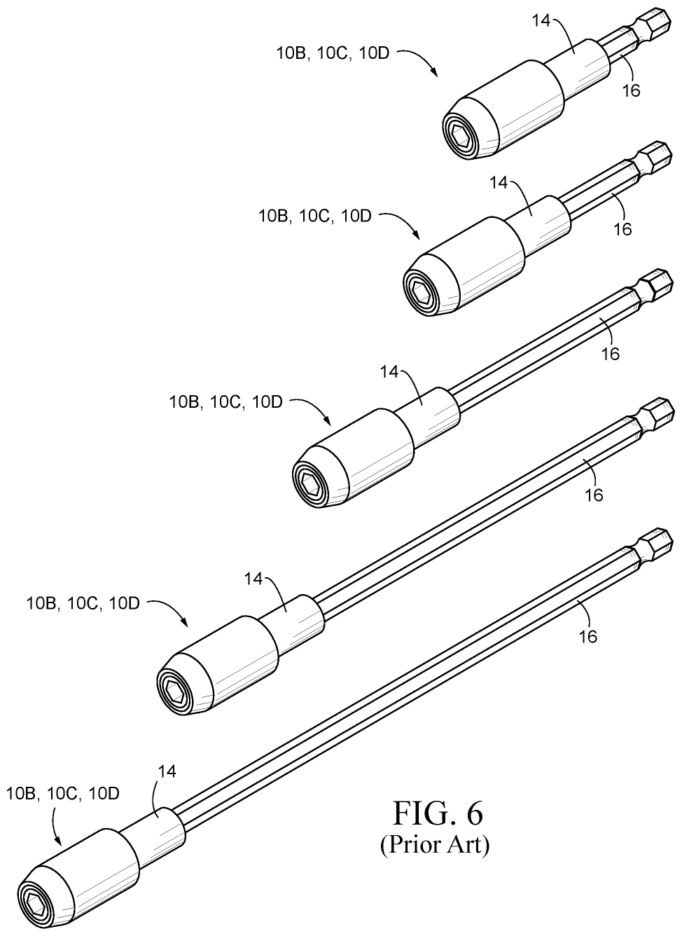

FIGS. 2A-2B are perspective views of one embodiment of a commercially available quick-change bit driver 10B for driver bits 60 such as manufactured by Jore Corporation and also sold under the brand names Jore® and Montana®. FIGS. 2C-2D are enlarged cross-sectional views of the quick-change bit driver 10B of FIGS. 2A and 2B respectively. The quick-change bit driver 10B includes a shaft 14 having a hex shaped drive shank 16 fixed at one end. In use, the free end of the drive shank 16 is received by a chuck of a power tool, such as a drill or impact driver (not shown). As represented by FIG. 6, the quick-change bit driver 10B may have different length drive shanks 16 fixed to the shaft 14. A central bore 18 extends into the shaft 14 opposite the drive shank 16. An aperture 28 (FIGS. 2C, 2D) extends radially through the shaft 14. A socket insert 30 is fixedly received in the central bore 18. The socket insert 30 includes a hex-shaped driver bit socket 32 sized to receive any of various complimentary driver bits 60. An aperture 34 (FIGS. 2C, 2D) extends radially through the socket insert 30 which aligns with the aperture 28 through the shaft 14. A detent ball or pin 36 is received within the aperture 34 and is biased inwardly toward the tool bit socket 32. The quick-change bit driver 10B includes a locking member 22 in the form of a sleeve that function in a manner similar to the locking member 22 of the quick-change bit driver 10A described above. The locking member 22 is moveable fore and aft along the shaft 14 between a release position (FIG. 2C) and a lock position (FIG. 2D). In the release position (FIG. 2C), the locking member 22 is moved forwardly with respect to the shaft 14. In this position, a recess 24 in the interior of the locking member 22 aligns with the apertures 28, 34 and with the detent pin 36. When the driver bit 60 is inserted into the driver bit socket 32, the detent pin 36 is forced radially outwardly through the apertures 28, 34 and into the recess 24. When the driver bit 60 is fully seated in the driver bit socket 32, a circumferential depression 63 in the driver bit 60 aligns with the detent pin 36 allowing the detent pin 36 to drop into the circumferential depression 63 in the driver bit 60. When the locking member 22 is moved rearwardly toward the shank 16 to the lock position (FIG. 2D), the detent pin 36 is held by the locking member 22 within the circumferential depression 63, thus locking the driver bit 60 within the driver bit socket 32. In some embodiments, the driver bit 60 may be magnetic and may not include a circumferential depression 63, in which event the driver bit 60 may be magnetically held within the driver bit socket 32 without the need to move the locking member 22 into the lock position.

FIGS. 3A-3B are perspective views of an embodiment of another commercially available quick-change bit driver 10C for driver bits 60 such as sold under the brand name Milwaukee®. The quick-change bit driver 10C is similar in construction and operation as the quick-change bit driver 10B sold under the brand names Jore® and Montana®, in that the quick-change bit driver 10C includes a shaft 14 having a hex shaped drive shank 16 fixed at one end. In use, the free end of the drive shank 16 is received by a chuck of a power tool, such as a drill or impact driver (not shown). As represented by FIG. 6, the quick-change bit driver 10C may have different length drive shanks 16 fixed to the shaft 14.

A hex-shaped central bore 18 extends into the shaft 14 opposite the drive shank 16 forming a hex-shaped driver bit socket 32 sized to complimentary receive any of the various driver bits 60. FIGS. 3C-3D are enlarged cross-sectional views of the quick-change bit driver 10C of FIGS. 3A and 3B respectively. An aperture 34 (FIG. 3C) extends radially through the shaft 14 into the hex-shaped tool bit socket 32. A detent pin 36 is received within the aperture 34. The quick-change bit driver 10C includes a locking member 22 in the form of a sleeve that functions in a manner similar to the locking member 22 of the quick-change bit driver 10B described above, in that the locking member 22 is moveable fore and aft along the shaft 14 between a release position (FIG. 3C) and a lock position (FIG. 3D), but in the quick-change bit driver 10C, the locking member 22 is in a normally forward-biased release position. In the normally forward biased release position, (FIG. 3C), a recess 24 in the interior of the locking member 22 aligns with the aperture 34 and the detent pin 36. When the driver bit 60 is inserted into the driver bit socket 32, the detent pin 36 is forced radially outwardly into the recess 24. When the driver bit 60 is fully seated in the driver bit socket 32, the circumferential depression 63 in the driver bit 60 aligns with the detent pin 36 allowing the detent pin 36 to drop into the circumferential depression 63 which simultaneously causes the locking member 22 to move to a rearwardly biased lock position (FIG. 3D) wherein the detent pin 36 is held by the locking member 22 within the circumferential depression 63 of the driver bit 60, thus locking the driver bit 60 within the driver bit socket 32 until a manual force is applied to move locking member 22 forward to the release position, wherein the recess 24 is again aligned with the aperture 34 and detent pin 36 permitting the detent pin 36 to move radially outwardly into the aperture 34 and recess 24. In some embodiments, the driver bit 60 may be magnetic and may not include a circumferential depression 63, in which event the driver bit 60 may be held within the driver bit socket 32 without the need to move the locking member 22 into the lock position.

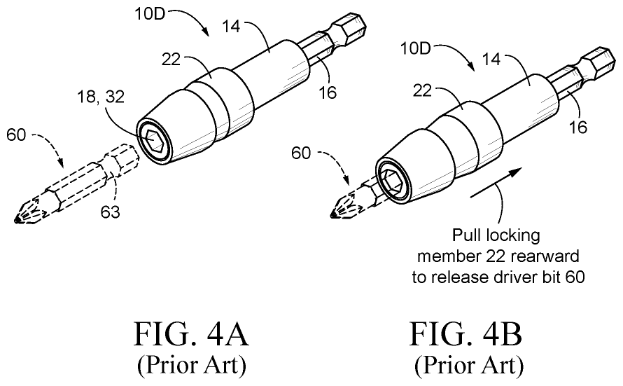

FIGS. 4A-4B are perspective views of an embodiment of another commercially available quick-change bit driver 10D for driver bits 60 such as sold under the brand name Malco®. The quick-change bit driver 10D is similar to the quick-change bit drivers 10B and 10C in that it includes a shaft 14 having a hex shaped drive shank 16 fixed at one end. In use, the free end of the drive shank 16 is received by a chuck of a power tool, such as a drill or impact driver (not shown). As represented by FIG. 6, the quick-change bit driver 10D may have different length drive shanks 16 fixed to the shaft 14.

A hex-shaped central bore 18 extends into the shaft 14 opposite the drive shank 16 forming a hex-shaped driver bit socket 32 sized to complimentary receive any of the various driver bits 60. The quick-change bit driver 10D also includes a locking member 22 movable between a release position and a lock position, but in this embodiment, the locking member 22 moves in the opposite direction for locking and unlocking the driver bit 60 compared to the locking members 22 of the quick-change bit drivers 10B and 10C previously described. With reference to FIG. 4A, the frustoconical shaped locking member 22 is biased in a normally forward position when no driver bit 60 is received within the driver bit socket 32. With reference to FIG. 4B, when the driver bit 60 is received in the driver bit socket 32, the conical shaped locking member 22 is forced rearwardly until the driver bit 60 is fully seated within the driver bit socket 32, at which point the driver bit 60 is locked within the driver bit socket 32 by a detent member (not shown). To release the driver bit 60, the frustoconical shaped locking member 22 is pulled rearwardly toward the shank 16 as shown by the arrow in FIG. 4B to overcome the forward bias on the locking member 22, thereby releasing the detent member and allowing the driver bit 60 to be removed from the driver bit socket 32.

With reference to FIG. 6, it should be appreciated that although the quick-change bit driver shown corresponds to the type illustrated in FIGS. 3A-3D, the quick-change bit drivers are labeled with reference numbers 10B, 10C and 10D to indicate that each of the quick-change bit drivers 10B, 10C and 10D may have different length drive shanks 16.

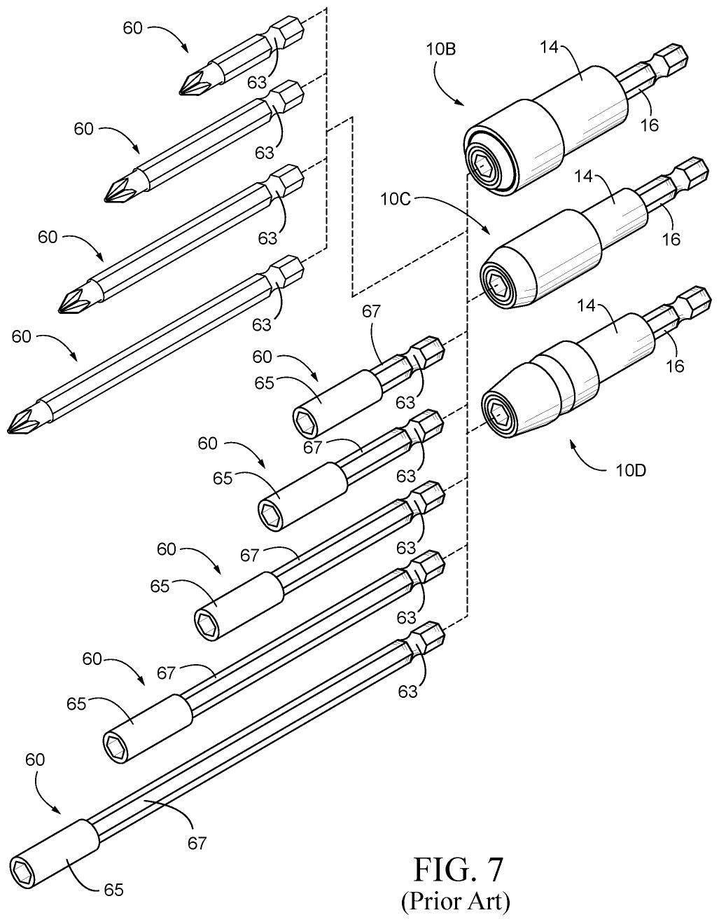

With reference to FIG. 7, the driver bits 60 are illustrated as crosshead/Philips® driver bits and as socket driver bits, wherein the socket driver bits comprise a socket 65 fixed to a hex-shaped shank 67. The socket 65 may be any number of conventional socket sizes and the shanks 67 may varying in length. It should also be appreciated that although the driver bits 60 are shown as crosshead/Philips® driver bits and socket drivers, the same reference number 60 is used to represent that any type of driver bit as previously defined above, regardless of length, is interchangeably receivable within any of the quick-change bit drivers 10B, 10C or 10D.

The above described commercially available quick-change bit drivers are intended as non-limiting examples. There are several other commercially available quick-change bit drivers manufactured and sold by other OEMs and as disclosed in U.S. Pat. Nos. 7,086,813 and 9,364,903, each of which is incorporated herein in their entireties.

For ease of reference, the driver bits 60, reversible drill/driver tools 50 and driver shanks 70 (discussed below) may be collectively referred to as tool bits 90.

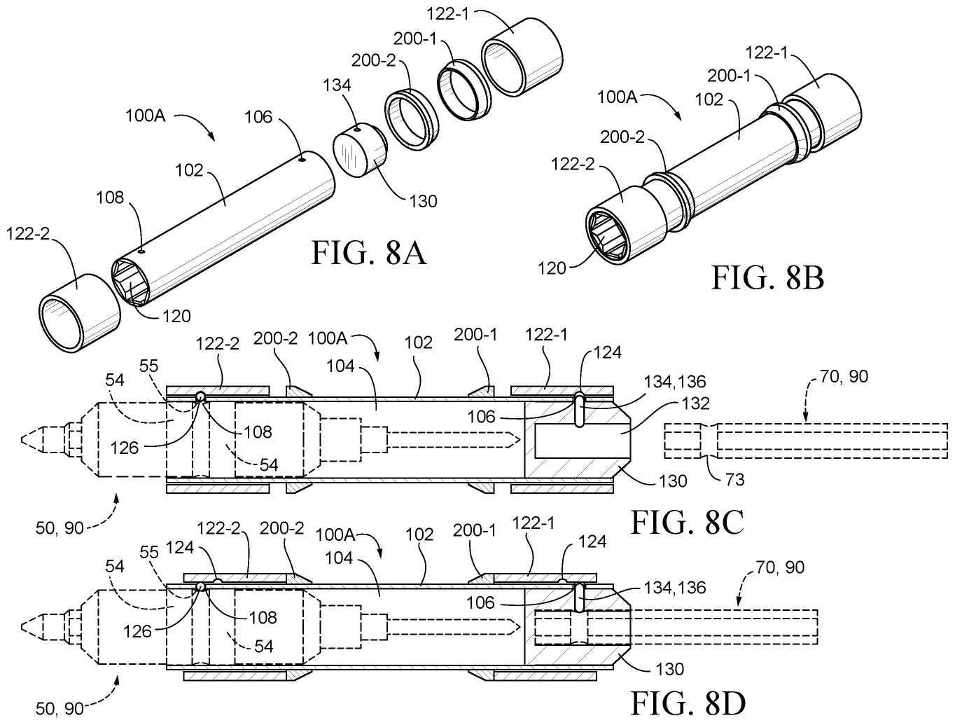

FIG. 8A is an exploded perspective view showing the components of one embodiment of a double-ended quick-change tool bit holder assembly 100A wherein a first end is configured similar to the quick-change bit driver 10B of FIG. 2A-2C to receive any type or length of driver shanks 70 and the other end is configured similar to the quick-change bit driver 10A of FIGS. 1A-1D to receive a reversible drill/driver tool 50.

The double-ended quick-change tool bit holder assembly 100A is comprised of a tubular shaft 102 having a first end with an interior diameter sized to fixedly receive a socket insert 130 substantially the same as the socket insert 30 of FIGS. 2A-2D. The second end of the tubular shaft 102 is configured with a socket 120 substantially the same as the socket 20 as previously described in connection with FIGS. 1A-1D so as to receive the complimentary configured shoulders 54 of the drill/driver tool 50. Thus, the length of the shaft 102 is sized to accommodate both the socket insert 130 and the drill/driver tool 50. A first aperture 106 is positioned near the first end of the shaft 102 and a second aperture 108 is positioned near the second end of the shaft 102, the purpose of which are described later.

The socket insert 130 includes a tool bit socket 132 having a size and configuration to receive a complimentary sized and configured driver shank 70. The driver shank 70 has a distal end adapted to be received by a chuck of a power tool, such as a drill or impact driver (not shown). The proximal end of the driver shank 70 may be hex-shaped, square or any other desired shape complimentary to the tool bit socket 132 in which the proximal end is adapted to be received. The proximal end of the driver shank 70 may include a circumferential depression 73 for purposes described below. The driver shank 70 may be any desired length and is interchangeable with any other desired length. The socket insert 130 includes an aperture 134 that extends radially through the socket insert 130 and into the tool bit socket 132. A detent ball or pin 136 is received within the aperture 134 and is biased inwardly toward the tool bit socket 132.

The exterior diameter of the tubular shaft 102 is sized to be received by first and second locking members 122-1, 122-2 configured the same as the locking members 20 as previously described in connection with any of the FIGS. 1A-1D and 2A-2C, respectively. Each of the first and second locking members 122-1, 122-2 is in the form of a sleeve with the first locking member 122-1 is disposed over the first end of the shaft 102 and the second locking member 122-2 disposed over the second end of the shaft 102. Each of the locking members 122-1, 122-2 is moveable fore and aft along the shaft 102 between a release position and a lock position. The locking members 122-1, 122-2 may be movably retained on the shaft 102 as disclosed in U.S. Pat. No. 6,176,654 previously incorporated herein by reference, or as otherwise recognized by those of ordinary skill in the art. The first locking member 122-1 cooperates with the socket insert 130 for releasing and locking the driver shank 70 within the tool bit socket 132. The second locking member 122-2 cooperates with the socket 120 at the second end of the shaft 102 for releasing and locking the complimentary reversible drill/driver 50 within the socket 120.

In the release position (FIG. 8C), the first locking member 122-1 is moved toward the first end of the shaft 102. In the lock position (FIG. 8D), the first locking member 122-1 is moved away from the first end and toward the second end of the shaft 102. When in the release position, a recess 124 in the interior of the first locking member 122-1 aligns with the aperture 106 in the shaft 102 and the aperture 134 in the socket insert 130. A detent ball or pin 36 is received within the aperture 134 and may be biased inwardly toward the tool bit socket 132. When the driver shank 70 is inserted into the tool bit socket 132, the detent pin 136 is forced radially outwardly through the aligned apertures 134, 106 and into the recess 124. When the driver shank 70 is fully seated in the tool bit socket 132, the circumferential depression 73 in the driver shank 70 aligns with the apertures 106, 134 allowing the detent pin 136 to drop into the circumferential depression 73 of the driver shank 70. When the locking member 122 is moved toward the second end of the shaft 102 into the lock position (FIG. 8D), the detent pin 136 is held by the first locking member 122-1 within the circumferential depression 73, thus locking the driver shank 70 within the tool bit socket 132.

The second locking member 122-2 at the second end of the shaft 102 is configured and functions substantially the same as the locking member 22 described in connection with FIGS. 1A-1D. In the release position (FIG. 8C), the second locking member 122-2 is moved toward the second end of the shaft 102. In the lock position (FIG. 8D), the second locking member 122-2 is moved away from the second end and toward the first end of the shaft 102. As previously described, the second end of the shaft 102 includes a hex-shaped socket 120 to receive the shoulders 54 of the drill/driver tool 50. When the second locking member 122-2 is in the release position (FIG. 8C), the second aperture 108 aligns with a recess 124 in the second locking member 122-2 and when the drill/driver tool 50 is inserted into the socket 120, the detent ball 126 is forced radially outwardly into the recess 124 by the hex shaped shoulders 54 of the drill/driver tool 50. When the shoulders 54 are fully seated in the socket 120, the detent ball 126 drops into the circumferential depression 55 between the hex shaped shoulders 54. As shown in FIG. 8D, when the second locking member 122-2 is moved to the lock position, the detent ball 126 is held by the second locking member 122-2 within the circumferential depression 55, thus locking the drill/driver tool 50 within the socket 120.

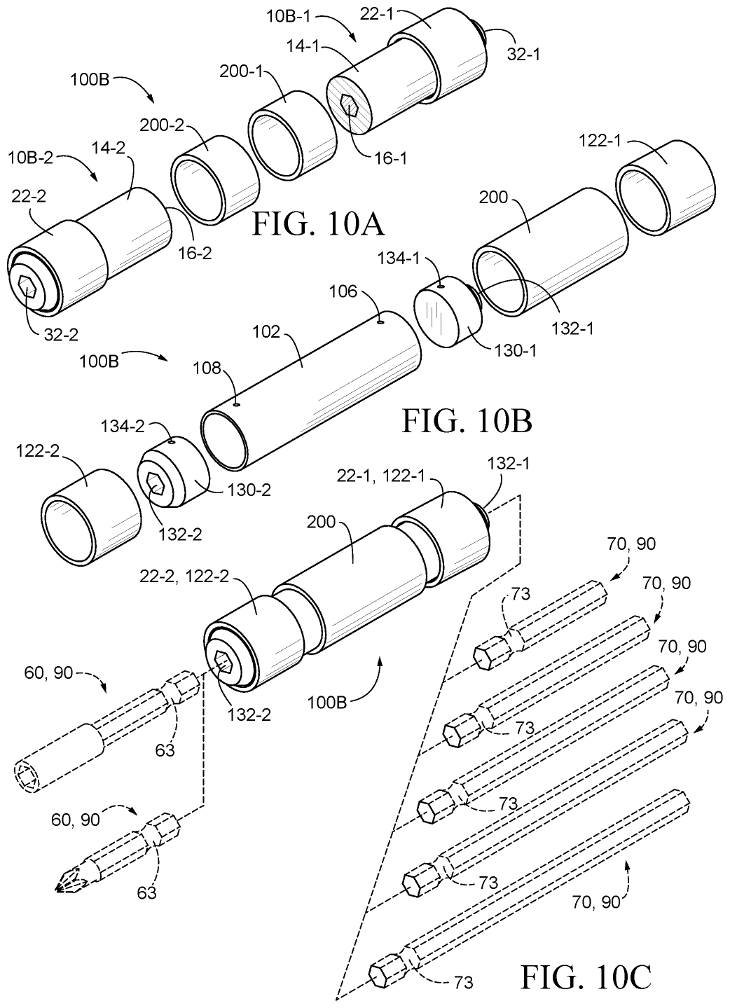

As disclosed in U.S. Pat. No. 8,607,673 (“the '673 patent”), the locking members 122-1, 122-2 are prone to inadvertently releasing the tool bits 90 when the locking members 122-1, 122-2 are inadvertently pushed into the release position, such as when the rearward or inward end of the locking member 122-1, 122-2 catches on an object, such as when pulling the drill from a holster on a toolbelt. Thus, the double-ended quick-change tool bit holder assembly 100A may be fitted with first and second collars 200-1, 200-2 positioned on the shaft 102 between the first and second locking members 122-1, 122-2. The first and second collars 200-1, 200-2 may have an inside diameter such that when press fit onto shaft 102 the collars 200-1, 200-2 will not move along the shaft 102. The collars 200-1, 200-2 may be conical annular rings such as shown in FIG. 8A or the collars 200-1, 200-2 may be cylindrical members as shown in FIG. 10A. The first and second collars 200-1, 200-2 may be press fit onto the shaft 102 from the respective first and second ends of the shaft before attaching the respective first and second locking members 122-1, 122-2 to the shaft 102. As best shown in FIG. 8D, the first and second collars are positioned toward the inward ends of the first and second locking members 122-1, 122-2 so that when the first and second locking members 122-1, 122-2 are in the lock position, the inward ends of the first and second locking members 122-1, 122-2 abut the outside face of the respective first and second collars 200-1, 200-2, thereby deflecting objects away from the inward ends of the first and second locking members 122-1, 122-2 and preventing the first and second locking members 122-1, 122-2 from being inadvertently pushed toward the release position which can result in the driver shank 70 and/or the drill/driver tool 50 from falling out of their respective sockets 132, 120.

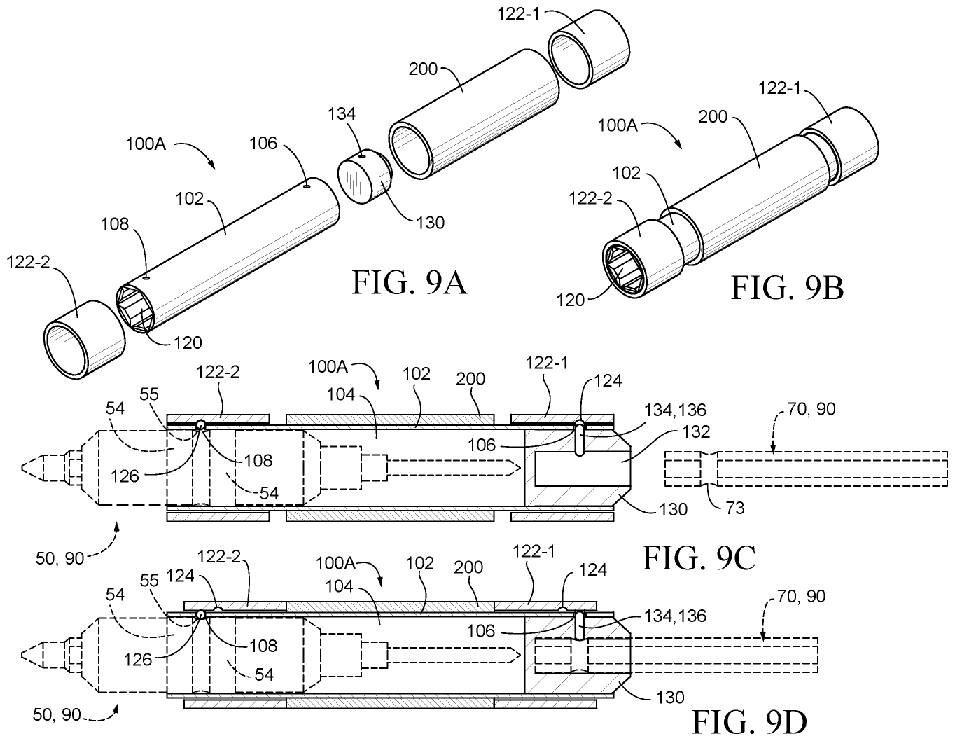

The double-ended quick-change tool bit holder assembly 100A as illustrated in FIGS. 9A-9D is substantially the same as the double-ended quick-change tool bit holder assembly 100A illustrated in FIGS. 8A-8D, except that instead of using two collars 200-1, 200-2 to prevent the inadvertent release of the driver shank 70 and/or reversible drill/driver 50, in FIGS. 9A-9D an elongated collar 200 is positioned on the shaft 102 between the first and second locking members 122-1, 122-2. The elongated collar 200 may have an inside diameter such that when press fit onto shaft 102 the collar 200 will not move along the shaft 102. The collar 200 may be press fit onto the shaft 102 from either the first or second end of the shaft 102 before both of the first and second locking members 122-1, 122-2 are attached to the shaft 102 or after one of the locking members 122-1, 122-2 is attached to the shaft 102. The elongated collar 200 has a length such that when the first and second locking members 122-1, 122-2 are in the lock position, the inward ends of the first and second locking members 122-1, 122-2 abut the outside ends of the collar 200. The elongated collar 200 has an outside diameter sufficient to ensure objects are deflected away from the inward ends of the first and second locking members 122-1, 122-2 in order to prevent the first and second locking members 122-1, 122-2 from being inadvertently pushed toward the release position which can result in the driver shank 70 and/or the drill/driver tool 50 from falling out of their respective sockets 132, 120.

FIG. 10A is an exploded perspective view of another embodiment of a double-ended quick-change tool bit holder assembly 100B showing the components thereof in one form of assembly. FIG. 10B is an exploded perspective view of the double-ended quick-change tool bit holder assembly 100B showing the components thereof in another form of assembly.

In FIG. 10A, the double-ended quick-change tool bit holder assembly 100B is fabricated using two OEM quick-change bit drivers 10B-1, 10B-2 attached end-to-end. In this embodiment, the two OEM quick-change bit drivers 10B-1, 10B-2 are shown as being of the type manufactured by Jore Corporation, sold under the brand names Jore® and Montana® as previously described in connection with FIGS. 2A-2D. Thus, each of the two OEM quick-change bit drivers 10B-1, 10B-2 has a respective shaft 14-1, 14-2 with a respective drive shank 16-1, 16-2 fixed thereto and each with a respective locking member 22-1, 22-2 that cooperates with a respective socket inserts 30-1, 30-2, each having a respective tool bit socket 32-1, 32-2. To fabricate the double-ended quick-change tool bit holder assembly 100B, the drive shanks 16-1, 16-2 are cut off, sawn off or otherwise removed from the ends of the respective shafts 14-1, 14-2, which may including cutting or sawing off a portion of the shafts 14-1, 14-2. The two inwardly facing ends of the shafts 14-1, 14-2 may then be welded together or otherwise rigidly fixed together resulting in the double-ended quick-change tool bit holder assembly 100B. Once fixed together, each of the two OEM quick-change bit drivers 10B-1, 10B-2, functions in the same manner as previously described in connection with FIGS. 2A-2D, and therefore the description of the components and their operation will not be repeated here. Thus, the first OEM quick-change bit driver 10B-1 at the first end of the double-ended quick-change tool bit holder assembly 100B is capable of lockably receiving a driver shank 70 within the first driver socket 32-1. The second OEM quick-change bit driver 10B-2 at the second end of the double-ended quick-change tool bit holder assembly 100B is capable of lockably receiving a driver bit 60 within the second driver socket 32-2. The driver shank 70 has a distal end adapted to be received by a chuck of a power tool, such as a drill or impact driver (not shown). The proximal end of the driver shank 70 may be hex-shaped, square or any other desired shape complimentary to the first tool bit socket 32-1. The proximal end of the driver shank 70 may include a circumferential depression 73 for cooperating with the detent pin or ball 36 for locking and unlocking the driver shank 70 therein by moving the first locking member 22-1 between the release position and the lock position as previously described in connection with FIGS. 2A-2D. The driver shank 70 may be any desired length and is interchangeable with any other desired length. Likewise, the second tool bit socket 32-2 may have a size and configuration to receive a complimentary sized and configured driver bit 60 such as previously described. The proximal end of the driver bit 60 may include a circumferential depression 63 for cooperating with the detent ball or pin 36 for locking and unlocking the driver bit 60 therein by moving the second locking member 22-2 between the release position and the lock position as previously described in connection with FIGS. 2A-2D.

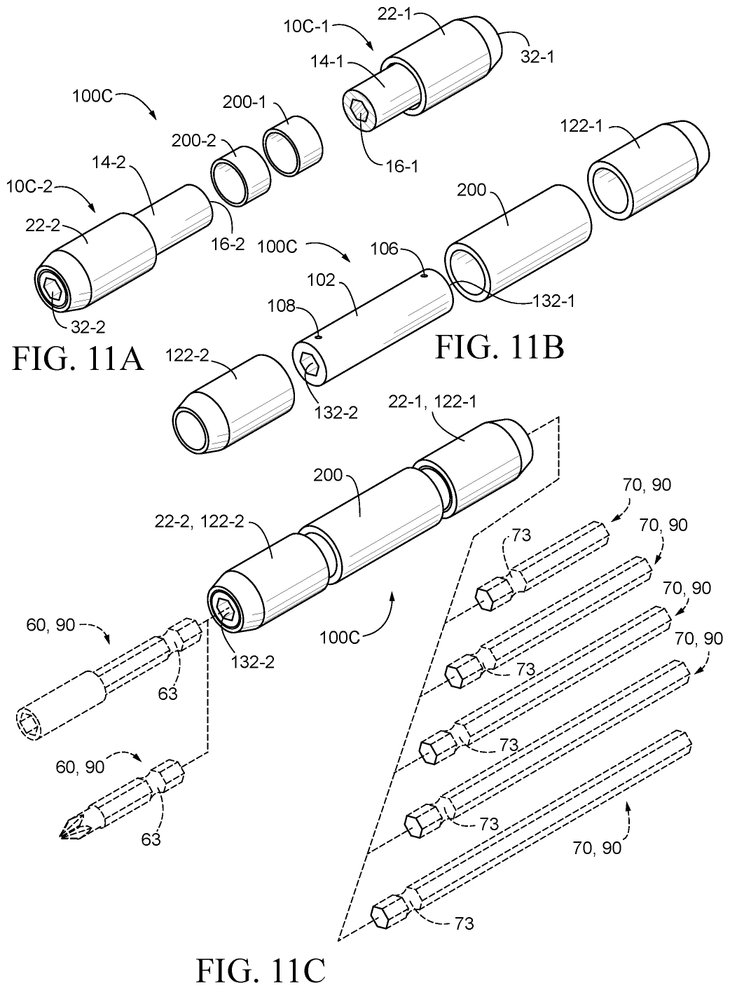

Additionally, to prevent the inadvertent release of the driver shank 70 and the driver bits 60 from the respective tool bit sockets 32-1, 32-2, the double-ended quick-change tool bit holder assembly 100B may incorporate first and second collars 200-1, 200-2 disposed on the first and second shafts 14-1, 14-2 between the respective first and second locking members 22-1, 22-2. Alternatively, as described in more detail later in connection with FIG. 10B, instead of two collars 200-1, 200-2, a single elongated collar 200 may be disposed on the first and second shafts 14-1, 14-2 between the first and second locking members 22-1, 22-2. With respect to the embodiment of FIG. 10A, the two collars 200-1, 200-2 may be cylindrical sections as shown in FIG. 11A, or the collars 200-1, 200-2 may be conical annular rings such as shown in FIG. 8A. The first and second collars 200-1, 200-2 may have an inside diameter such that they may be press fit onto the respective first and second shafts 14-1, 14-2 so they will not move along the shafts 14-1, 14-2. It should be appreciated that the first and second collars 200-1, 200-2 are positioned toward the inward ends of the first and second locking members 22-1, 22-2 so that when the first and second locking members 22-1, 22-2 are in the lock position, the inward ends of the first and second locking members 22-1, 22-2 abut the outside face of the respective first and second collars 200-1, 200-2, thereby deflecting objects away from the inward ends of the first and second locking members 22-1, 22-2 and preventing the first and second locking members 22-1, 22-2 from being inadvertently pushed toward the release position which can result in the tool bits 90 from falling out of their respective tool bit sockets 32-1, 32-2 at each end. The first and second collars 200-1, 200-2 may be press fit onto the ends of the respective shafts 14-1, 14-2 of the two OEM quick-change bit drivers 10B-1, 10B-2 before the ends of the two shafts 14-1, 14-2 are fixed together to create the double-ended quick-change tool bit holder assembly 100B.

The other form of assembly of the double-ended quick-change tool bit holder assembly 100B shown in FIG. 10B, comprises a tubular shaft 102 having first and second ends, each with an interior diameter sized to fixedly receive respective first and second socket inserts 130-1, 130-2, each configured substantially the same as the driver socket 30 described in connection with FIGS. 2A-2D. A first aperture 106 is positioned near the first end of the shaft 102 and a second aperture 108 is positioned near the second end of the shaft 102. The first socket insert 130-1 includes a tool bit socket 132-1 having a size and configuration to receive a complimentary sized and configured driver shank 70. The driver shank 70 has a distal end adapted to be received by a chuck of a power tool, such as a drill or impact driver (not shown). The proximal end of the driver shank 70 may be hex-shaped, square or any other desired shape complimentary to the tool bit socket 132-1 in which the proximal end is adapted to be received. The proximal end of the driver shank 70 may include a circumferential depression 73 for purposes described below. The driver shank 70 may be any desired length and is interchangeable with any other desired length. Likewise, the second socket insert 130-2 includes a tool bit socket 132-2 having a size and configuration to receive a complimentary sized and configured driver bits 60 as previously described. Each of the first and second socket inserts 130-1, 130-2 includes an aperture 134 extending radially into its respective tool bit socket 132-1, 132-2. A detent ball or pin 136 is received within the aperture 134 and may be biased inwardly toward the respective tool bit socket 132-1, 132-2.

The exterior diameter of the tubular shaft 102 is sized to be received by first and second locking members 122-1, 122-2 configured substantially the same as the locking members 22 as previously described in connection with FIGS. 2A-2D. Thus, each of the first and second locking members 122-1, 122-2 is in the form of a sleeve with the first locking member 122-1 disposed over the first end of the shaft 102 and the second locking member 122-2 disposed over the second end of the shaft 102. Each of the locking members 122-1, 122-2 is moveable fore and aft along the shaft 102 between a release position and a lock position. The locking members 122-1, 122-2 may be movably retained on the shaft 102 by retaining clips (not shown) or as otherwise recognized by those of ordinary skill in the art. The first locking member 122-1 cooperates with the first socket insert 130-1 for releasing and locking the driver shank 70 within the first tool bit socket 132-1. The second locking member 122-2 cooperates with the second socket insert 130-2 at the second end of the shaft 102 for releasing and locking the driver bits 60 within the second tool bit socket 132-2. Thus, it should be appreciated that the operation of each of the first and second locking members 122-1, 122-2 are the same as previously described in connection with FIGS. 2A-2D. Accordingly, when the first locking member 122-1 is in the release position, the first locking member 122-1 is moved toward the first end of the shaft 102. In the lock position, the first locking member 122-1 is moved away from the first end and toward the second end of the shaft 102. When in the release position, a recess 124-1 in the interior of the first locking member 122-1 aligns with the aperture 134-1 in the first socket insert 130-1 and the first aperture 106 in the shaft 102. The detent ball or pin 136 received within the aperture 134-1 may be biased inwardly toward the first tool bit socket 132-1. When the driver shank 70 is inserted into the first tool bit socket 132-1, the detent pin 136 is forced radially outwardly through the aligned apertures 106, 134-1 into the recess 124-1. When the driver shank 70 is fully seated in the first tool bit socket 132-1, the circumferential depression 73 in the driver shank 70 aligns with the apertures 106, 134-1 allowing the detent pin 136 to drop into the circumferential depression 73 in the driver shank 70. When the first locking member 122-1 is moved toward the second end of the shaft 102 into the lock position, the detent pin 136 is held by the first locking member 122-1 within the circumferential depression 73, thus locking the driver shank 70 within the first tool bit socket 132-1. Similarly, when the second locking member 122-2 is in the release position, the second locking member 122-2 is moved toward the second end of the shaft 102. In the lock position, the second locking member 122-2 is moved away from the second end and toward the first end of the shaft 102. When in the release position, a recess 124-2 in the interior of the second locking member 122-2 aligns with the aperture 134-2 in the second socket insert 130-2 and the second aperture 108 in the shaft 102. The detent ball or pin 136 received within the aperture 134-2 may be biased inwardly toward the second tool bit socket 132-2. When the driver bit 60 is inserted into the second tool bit socket 132-2, the detent pin 136 is forced radially outwardly through the aligned apertures 108, 134-2 and into the recess 124-2. When the driver bit 60 is fully seated in the second tool bit socket 132-2, the circumferential depression 63 in the driver bit 60 aligns with the apertures 108, 134-2 allowing the detent pin 136 to drop into the circumferential depression 63. When the second locking member 122-2 is moved toward the first end of the shaft 102 into the lock position, the detent pin 136 is held by the second locking member 122-2 within the circumferential depression 63 of the driver bit 60, thus locking the driver bit 60 within the second tool bit socket 132-2.

Additionally, to prevent the inadvertent release of the driver shank 70 and the driver bits 60 from the respective tool bit sockets 132-1, 132-2, the double-ended quick-change tool bit holder assembly 100B may incorporate first and second collars 200-1, 200-2 disposed on the shaft 102 between the respective first and second locking members 122-1, 122-2 as described above in connection with FIG. 10A, or, as shown in FIG. 10B, the two collars 200-1, 200-2 may be replaced with a single elongated collar 200 disposed on the shaft 102 between the first and second locking members 122-1, 122-2. In embodiments with the single elongated collar 200, the single elongated collar may have an inside diameter such that it may be press fit onto shaft 102 (or shafts 14-1, 14-2 in the embodiment of FIG. 10A) so that it will not move along the shaft 102 (or shafts 14-1, 14-2). In embodiments with two collars 200-1, 200-2, the collars 200-1, 200-2 may each have an inside diameter such that they may be press fit onto shaft 102 so they will not move along the shaft 102. The elongated collar 200 may be press fit onto the shaft 102 from either the first or second end of the shaft 102 before both of the first and second locking members 122-1, 122-2 are attached to the shaft 102 or after one of the locking members 122-1, 122-2 is attached to the shaft 102. As shown in FIGS. 9C and 9D, the elongated collar 200 may have a length such that when the first and second locking members 122-1, 122-2 are in the lock position, the inward ends of the first and second locking members 122-1, 122-2 abut the outside ends of the elongated collar 200. The elongated collar 200 may have an outside diameter sufficient to ensure objects are deflected away from the inward ends of the first and second locking members 122-1, 122-2 in order to prevent the first and second locking members 122-1, 122-2 from being inadvertently pushed toward the release position which can result in the driver bits 60 and the diver shank 70 from falling out of their respective first and second tool bit sockets 132-1, 132-2.

FIG. 10C is intended to show the assembled double-ended quick-change tool bit holder assembly 100B constructed in accordance with either FIG. 10A or 10B. Although FIG. 10C shows the double-ended quick-change tool bit holder assembly 100B with the single elongated collar 200, it should be appreciated that the single elongated collar 200 could be replaced with the two collar rings 200-1, 200-2 as shown in FIGS. 10A and 8A. FIG. 10C is also intended to represent that any length driver shank 70 may be interchangeably inserted into the first tool bit socket 132-1 and any type of driver bit 60 of any length may be interchangeably inserted into the second tool bit socket 132-2 such as described in connection with FIG. 6 and vice-versa.

FIG. 11A is an exploded perspective view of another embodiment of a double-ended quick-change tool bit holder assembly 100C showing the components thereof in one form of assembly. FIG. 11B is an exploded perspective view of the double-ended quick-change tool bit holder assembly 100C showing the components thereof in another form of assembly.

In FIG. 11A, the double-ended quick-change tool bit holder assembly 100C is fabricated using two OEM quick-change bit drivers 10C-1, 10C-2 attached end-to-end. In this embodiment, the two OEM quick-change bit drivers 10C-1, 10C-2 are shown as being of the type sold under the brand name Milwaukee®, as previously described in connection with FIGS. 3A-3D. Thus, each of the two OEM quick-change bit drivers 10C-1, 10C-2 has a respective shaft 14-1, 14-2 with a respective drive shank 16-1, 16-2 fixed thereto and each with a respective locking member 22-1, 22-2 that cooperates with a respective tool bit socket 32-1, 32-2. To fabricate the double-ended quick-change tool bit holder assembly 100C, the drive shanks 16-1, 16-2 are cut off, sawn off or otherwise removed from the ends of the respective shafts 14-1, 14-2, which may including cutting or sawing off a portion of the shafts 14-1, 14-2. The two inwardly facing ends of the shafts 14-1, 14-2 may then be welded together or otherwise rigidly fixed together resulting in the double-ended quick-change tool bit holder assembly 100C. Once fixed together, each of the two OEM quick-change bit drivers 10C-1, 10C-2, functions in the same manner as previously described in connection with FIGS. 3A-3D, and therefore the description of the components and their operation will not be repeated here. Thus, the first OEM quick-change bit driver 10C-1 at the first end of the double-ended quick-change tool bit holder assembly 100C is capable of lockably receiving a driver shank 70 within the first tool bit socket 32-1. The second OEM quick-change bit driver 10C-2 at the second end of the double-ended quick-change tool bit holder assembly 100C is capable of lockably receiving a driver bit 60 within the second tool bit socket 32-2. The driver shank 70 has a distal end adapted to be received by a chuck of a power tool, such as a drill or impact driver (not shown). The proximal end of the driver shank 70 may be hex-shaped, square or any other desired shape complimentary to the first driver socket 32-1. The proximal end of the driver shank 70 may include a circumferential depression 73 for cooperating with the detent pin or ball 36 for locking and unlocking the driver shank 70 therein by moving the first locking member 22-1 between the release position and the lock position as previously described in connection with FIGS. 3A-3D. The driver shank 70 may be any desired length and is interchangeable with any other desired length. Likewise, the second tool bit socket 32-2 may have a size and configuration to receive a complimentary sized and configured driver bit 60 such as previously described. The proximal end of the driver bit 60 may include a circumferential depression 63 for cooperating with the detent ball or pin 36 for locking and unlocking the driver bit 60 therein by moving the second locking member 22-2 between the release position and the lock position as previously described in connection with FIGS. 3A-3D.

Additionally, to prevent the inadvertent release of the driver shank 70 and the driver bits 60 from the respective tool bit sockets 32-1, 32-2, the double-ended quick-change tool bit holder assembly 100C may incorporate first and second collars 200-1, 200-2 disposed on the first and second shafts 14-1, 14-2 between the respective first and second locking members 22-1, 22-2. Alternatively, as described in more detail later in connection with FIG. 11B, instead of two collars 200-1, 200-2, a single elongated collar 200 may be disposed on the first and second shafts 14-1, 14-2 between the first and second locking members 22-1, 22-2. With respect to the embodiment of FIG. 11A, the two collars 200-1, 200-2 may be cylindrical sections as shown in FIG. 11A, or the collars 200-1, 200-2 may be conical annular rings such as shown in FIG. 8A. The first and second collars 200-1, 200-2 may have an inside diameter such that they may be press fit onto the respective shaft first and second shafts 14-1, 14-2 so they will not move along the shafts 14-1, 14-2. It should be appreciated that the first and second collars 200-1, 200-2 are positioned toward the inward ends of the first and second locking members 22-1, 22-2 so that when the first and second locking members 22-1, 22-2 are in the lock position, the inward ends of the first and second locking members 22-1, 22-2 abut the outside face of the respective first and second collars 200-1, 200-2, thereby deflecting objects away from the inward ends of the first and second locking members 22-1, 22-2 and preventing the first and second locking members 22-1, 22-2 from being inadvertently pushed toward the release position which can result in the tool bits 90 from falling out of their respective tool bit sockets 32-1, 32-2 at each end. The first and second collars 200-1, 200-2 may be press fit onto the ends of the respective shafts 14-1, 14-2 of the two OEM quick-change bit drivers 10C-1, 10C-2 before the ends of the two shafts 14-1, 14-2 are fixed together to create the double-ended quick-change tool bit holder assembly 100C.

The other form of assembly of the double-ended quick-change tool bit holder assembly 100C shown in FIG. 11B, comprises a tubular shaft 102 having first and second ends, with each of the first and second ends having respective first and second tool bit sockets 132-1, 132-2 sized and configured to receive complimentary sized and configured driver bits 60 and driver shanks 70. The driver shank 70 has a distal end adapted to be received by a chuck of a power tool, such as a drill or impact driver (not shown). The proximal end of the driver shank 70 may be hex-shaped, square or any other desired shape complimentary to the first tool bit socket 132-1 in which the proximal end is adapted to be received. The proximal end of the driver shank 70 may include a circumferential depression 73 for purposes described below. The driver shank 70 may be any desired length and is interchangeable with any other desired length. Likewise, the second tool bit socket 132-2 may have a size and configuration to receive a complimentary sized and configured driver bit 60 such as previously described. The shaft 102 includes first and second apertures 106, 108 proximate the respective first and second ends of the shaft 102 extending radially into the respective first and second tool bit sockets 132-1, 132-2. A detent ball or pin 136 is received within each of the first and second apertures 106, 108 and may be biased inwardly toward the respective first and second tool bit sockets 132-1, 132-2.

The exterior diameter of the tubular shaft 102 is sized to be received by first and second locking members 122-1, 122-2 configured substantially the same as the locking members 22 as previously described in connection with FIGS. 3A-3D. Thus, each of the first and second locking members 122-1, 122-2 is in the form of a sleeve with the first locking member 122-1 disposed over the first end of the shaft 102 and the second locking member 122-2 disposed over the second end of the shaft 102. Each of the locking members 122-1, 122-2 is moveable fore and aft along the shaft 102 between a release position and a lock position. The locking members 122-1, 122-2 may be movably retained on the shaft 102 by retaining clips (not shown) or as otherwise recognized by those of ordinary skill in the art. The first locking member 122-1 cooperates with the first tool bit socket 132-1 for releasing and locking the driver shank 70 within the first tool bit socket 132-1. The second locking member 122-2 cooperates with the second tool bit socket 132-2 at the second end of the shaft 102 for releasing and locking the driver bits 60 within the second tool bit socket 132-2. Thus, it should be appreciated that the operation of each of the first and second locking members 122-1, 122-2 are the same as previously described in connection with FIGS. 3A-3D. Accordingly, when the first locking member 122-1 is in the release position, the first locking member 122-1 is moved toward the first end of the shaft 102. In the lock position, the first locking member 122-1 is moved away from the first end and toward the second end of the shaft 102. When in the release position, a recess 124-1 in the interior of the first locking member 122-1 aligns with the first aperture 106 in the shaft 102 and the detent pin 136. The detent pin 136 received within the first aperture 106 may be biased inwardly toward the first tool bit socket 132. When the driver shank 70 is inserted into the first tool bit socket 132-1, the detent pin 136 is forced radially outwardly through the first aperture 106 and into the recess 124-1. When the driver shank 70 is fully seated in the first tool bit socket 132-1, the circumferential depression 73 in the driver shank 70 aligns with the first aperture 106 and the detent pin 136 allowing the detent pin 136 to drop into the circumferential depression 73 in the driver shank 70. When the first locking member 122-1 is moved toward the second end of the shaft 102 into the lock position, the detent pin 136 is held by the first locking member 122-1 within the circumferential depression 73, thus locking the driver shank 70 within the first tool bit socket 132-1. Similarly, when the second locking member 122-2 is in the release position, the second locking member 122-2 is moved toward the second end of the shaft 102. In the lock position, the second locking member 122-2 is moved away from the second end and toward the first end of the shaft 102. When in the release position, a recess 124-2 in the interior of the second locking member 122-2 aligns with the second aperture 108 in the shaft 102 and the detent pin 136. The detent ball or pin 136 received within the aperture 134 may be biased inwardly toward the second tool bit socket 132-2. When the driver bit 60 is inserted into the second tool bit socket 132-2, the detent pin 136 is forced radially outwardly through the second aperture 108 into the recess 124-2. When the driver bit 60 is fully seated in the second tool bit socket 132-2, the circumferential depression 63 in the driver bit 60 aligns with the aperture 108 and the detent pin 136, allowing the detent pin 136 to drop into the circumferential depression 63 in the driver bit 60. When the second locking member 122-2 is moved toward the first end of the shaft 102 and away from the second end of the shaft 102, into the lock position, the detent pin 136 is held by the second locking member 122-2 within the circumferential depression 63, thus locking the driver bit 60 within the second tool bit socket 132-2.

Additionally, to prevent the inadvertent release of the driver shank 70 and the driver bits 60 from the respective tool bit sockets 132-1, 132-2, the double-ended quick-change tool bit holder assembly 100C may incorporate first and second collars 200-1, 200-2 disposed on the shaft 102 between the respective first and second locking members 122-1, 122-2 as described above in connection with FIG. 11A, or, as shown in FIG. 11B, the two collars 200-1, 200-2 may be replaced with a single elongated collar 200 disposed on the shaft 102 between the first and second locking members 122-1, 122-2. In embodiments with the single elongated collar 200, the single elongated collar may have an inside diameter such that it may be press fit onto shaft 102 (or shafts 14-1, 14-2 in the embodiment of FIG. 11A) so that it will not move along the shaft 102 (or shafts 14-1, 14-2). In embodiments with two collars 200-1, 200-2, the collars 200-1, 200-2 may each have an inside diameter such that they may be press fit onto shaft 102 so they will not move along the shaft 102. As shown in FIGS. 9C and 9D, the elongated collar 200 may have a length such that when the first and second locking members 122-1, 122-2 are in the lock position, the inward ends of the first and second locking members 122-1, 122-2 abut the outside ends of the elongated collar 200. The elongated collar 200 may have an outside diameter sufficient to ensure objects are deflected away from the inward ends of the first and second locking members 122-1, 122-2 in order to prevent the first and second locking members 122-1, 122-2 from being inadvertently pushed toward the release position which can result in the driver bits 60 and the diver shank 70 from falling out of their respective first and second tool bit socket 132-1, 132-2.

FIG. 11C is intended to show the assembled double-ended quick-change tool bit holder assembly 100C constructed in accordance with either FIG. 11A or 11B. Although FIG. 11C shows the double-ended quick-change tool bit holder assembly 100C with the single elongated collar 200, it should be appreciated that the single elongated collar 200 could be replaced with the two collar rings 200-1, 200-2 as shown in FIGS. 11A and 8A. FIG. 11C is also intended to represent that any length driver shank 70 may be interchangeably inserted into the first tool bit socket 132-1 and any type of driver bit 60 of any length may be interchangeably inserted into the second tool bit socket 132-2 such as described in connection with FIG. 6 and vice-versa.

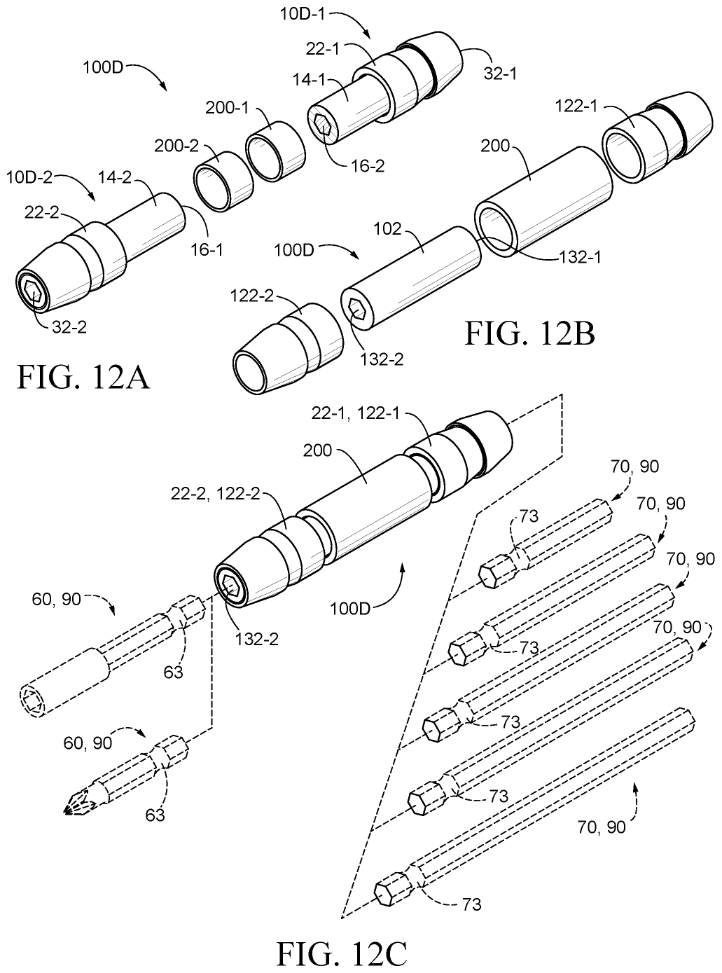

FIG. 12A is an exploded perspective view of another embodiment of a double-ended quick-change tool bit holder assembly 100D showing the components thereof in one form of assembly. FIG. 12B is an exploded perspective view of the double-ended quick-change tool bit holder assembly 100D showing the components thereof in another form of assembly.

In FIG. 12A, the double-ended quick-change tool bit holder assembly 100D is constructed using two OEM quick-change bit drivers 10D-1, 10D-2 attached end to end. In this embodiment, the two OEM quick-change bit drivers 10D-1, 10D-2 are shown as being of the type sold under the brand name Malco®, as previously described in connection with FIGS. 4A-4B. Thus, each of the two OEM quick-change bit drivers 10D-1, 10D-2 has a respective shaft 14-1, 14-2 with a respective drive shank 16-1, 16-2 fixed thereto and each with a respective locking member 22-1, 22-2 that cooperates with a respective tool bit socket 32-1, 32-2. To fabricate the double-ended quick-change tool bit holder assembly 100D, the drive shanks 16-1, 16-2 are cut off, sawn off or otherwise removed from the ends of the respective shafts 14-1, 14-2, which may including cutting or sawing off a portion of the shafts 14-1, 14-2. The two inwardly facing ends of the shafts 14-1, 14-2 may then be welded together or otherwise rigidly fixed together resulting in the double-ended quick-change tool bit holder assembly 100D. Once fixed together, each of the two OEM quick-change bit drivers 10D-1, 10D-2, functions in the same manner as previously described in connection with FIGS. 4A-4B, and therefore the description of the components and their operation will not be repeated here. Thus, the first OEM quick-change bit driver 10D-1 at the first end of the double-ended quick-change tool bit holder assembly 100D is capable of lockably receiving a driver shank 70 within the first tool bit socket 32-1. The second OEM quick-change bit driver 10D-2 at the second end of the double-ended quick-change tool bit holder assembly 100D is capable of lockably receiving a driver bit 60 within the second tool bit socket 32-2. The driver shank 70 has a distal end adapted to be received by a chuck of a power tool, such as a drill or impact driver (not shown). The proximal end of the driver shank 70 may be hex-shaped, square or any other desired shape complimentary to the first tool bit socket 32-1. The proximal end of the driver shank 70 may include a circumferential depression 73 for cooperating with the first locking member 22-1 for locking and unlocking the driver shank 70 within the first tool bit socket 32-1 when the first locking member 22-1 is being moved between the lock position and release position as previously described in connection with FIGS. 4A-4B. The driver shank 70 may be any desired length and is interchangeable with any other desired length. Likewise, the second tool bit socket 32-2 may have a size and configuration to receive a complimentary sized and configured driver bit 60 such as previously described. The proximal end of the driver bit 60 may include a circumferential depression 63 for cooperating with second locking member 22-2 for locking and unlocking the driver bit 60 within the second tool bit socket 32-2 when the second locking member 22-2 is being moved between the lock position and release position as previously described in connection with FIGS. 4A-4B, wherein the first and second locking members 22-1, 22-2 move in the opposite direction for locking and unlocking the respective driver shanks 70 and driver bits 60 compared to the locking members 22-1, 22-2 of the other double-ended quick-change tool bit holder assemblies 100B and 100C of FIGS. 10A and 11A, respectively.

The other form of assembly of the double-ended quick-change tool bit holder assembly 100D shown in FIG. 12B, comprises a tubular shaft 102 having first and second ends, with each of the first and second ends having respective first and second tool bit sockets 132-1, 132-20 sized and configured to receive complimentary sized and configured driver shanks 70 and driver bits 60 therein. The driver shank 70 has a distal end adapted to be received by a chuck of a power tool, such as a drill or impact driver (not shown). The proximal end of the driver shank 70 may be hex-shaped, square or any other desired shape complimentary to the first tool bit socket 132-1 in which the proximal end is adapted to be received. The proximal end of the driver shank 70 may include a circumferential depression 73 for purposes described below. The driver shank 70 may be any desired length and is interchangeable with any other desired length. Likewise, the second tool bit socket 132-2 may have a size and configuration to receive a complimentary sized and configured driver bit 60 such as previously described.

The exterior diameter of the tubular shaft 102 is sized to be received by first and second locking members 122-1, 122-2 movable between a release position and a lock position and configured substantially the same as the locking members 22 as previously described in connection with FIGS. 4A-4B. The locking members 122-1, 122-2 may be movably retained on the shaft 102 by retaining clips (not shown) or as otherwise recognized by those of ordinary skill in the art. As previously described in connection with the locking members 22 of the quick-change bit driver 10D of FIGS. 4A-4B, the direction of movement of the first and second locking members 122-1, 122-2 is opposite of the direction of movement of the locking members 122-1, 122-2 of the double-ended quick-change tool bit holder assemblies 100B and 100C previously described. With reference to FIG. 12B, the frustoconical shaped locking members 122-1, 122-2 are biased in the release position when no tool bit 90 is received within the tool bit sockets 132-1, 132-2. When the tool bit 90 is received in the respective tool bit socket 132-1, 132-2, the conical shaped locking member 122-1, 122-2 is forced away from the respective first end or second end until the tool bit 90 is fully seated within the respective tool bit sockets 132-1, 132-2, at which point the tool bits 90 are locked within the respective tool bit sockets 132-1, 132-2 by a detent member (not shown). To release the driver shank 70 from the first tool bit socket 132-1, the frustoconical shaped first locking member 122-1 is pulled in a direction away from the first end toward the second end of the shaft 102 (see the arrow in FIG. 4B) to overcome the bias on the first locking member 122-1, thereby releasing the detent member and allowing the driver shank 70 to be removed from the first tool bit socket 132-1. Similarly, to release the driver bit 60 from the second tool bit socket 132-2, the frustoconical shaped second locking member 122-2 is pulled in a direction away from the second end toward the first end of the shaft 102 (see the arrow in FIG. 4B) to overcome the bias on the locking member 122-1, 122-2, thereby releasing the detent member and allowing the driver bit 60 to be removed from the second tool bit socket 132-2.

In the double-ended quick-change tool bit holder assembly 100D, collars 200-1, 200-2, 200 are not needed to prevent the inadvertent release of the driver bits 60, 70 from the respective first and second tool bit socket 32-1, 132-1, 32-2, 132-2, because the first and second locking member 22-1, 22-2, 122-1, 122-2 move in the opposite direction compared to the double-ended quick-change tool bit holder assemblies 100A, 100B, 100C. Nevertheless, it may still be desirable to employ the collars 200-1, 200-2 or a single elongated collar 200 on the double-ended quick-change tool bit holder assembly 100D because the collar 200-1, 200-2, 200 would provide a larger diameter area for a user to grasp the double-ended quick-change tool bit holder assembly 100D while being handled.

In all embodiments of the double-ended quick-change tool bit holder assemblies 100A, 100B, 100C, 100D, the collar 200 or collars 200-1, 200-2 may be knurled to provide a better gripping surface when the double-ended quick-change tool bit holder assembly 100A, 100B, 100C, 100D is being handled.

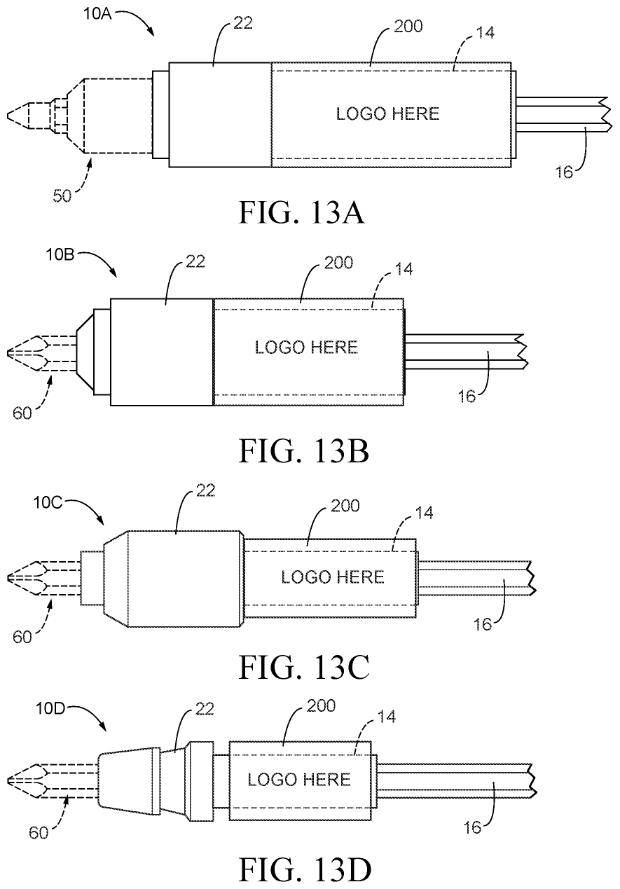

An additional benefit of providing an elongated collar 200 as described above is that the elongated collar provides a large surface are for placement of a brand name, logo, trademark or other identifier. As shown in FIGS. 13A-13D, an elongated collar incorporating a brand name, logo, trademark or other identifier could also be used on any of the commercially available OEM quick-change bit drivers 10A, 10B, 10C, 10D described above.

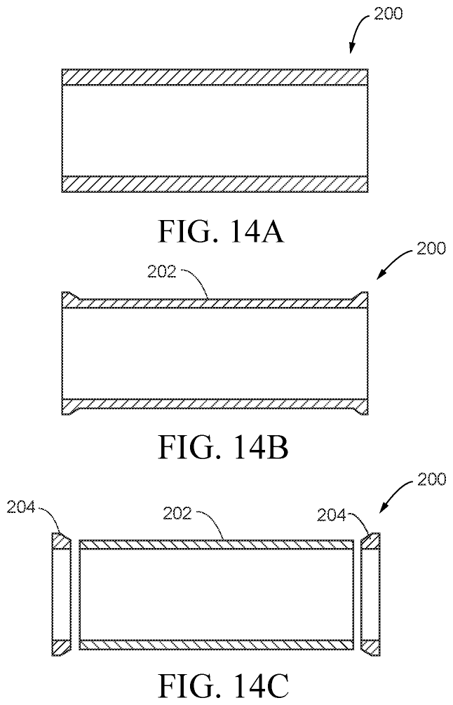

Additionally, instead of the elongated collar 200 having a uniform thickness along its length as shown in the cross-sectional view of FIG. 14A, the elongated collar 200 may have a thin wall portion 202 with one or more flared or conical ends 204 formed integral with the thin walled portion 202 as shown in FIG. 14B. The flared conical ends 204 may serve to deflect objects away from the ends of the locking members 22, 122-1, 122-2 to prevent the locking members 22, 122-1, 122-2 from being inadvertently moved into the release position as described above. In yet another embodiment, as shown in FIG. 14C, the collar 200 may comprise a thin walled portion 202 with separate flared or conical rings 204 at one or both ends of the thin walled portion 202.

In any of the embodiments, the collar 200, 200-1, 200-2 may be made from any suitable material, including, but not limited to, any type of metal compatible with the metal from which the shafts 14-1, 14-2, 102 are made, or any type of plastic or polymer material. It has been found the Delrin® plastic is particularly suitable for the collar 200, 200-1, 200-2 because it is well suited for forming precision parts due to its high modulus of elasticity, high strength, rigidity, dimensional stability, resistance to chemicals, solvents and moisture, and high-wear resistance. Additionally, Delrin® plastic is suitable for screen printing, etching, or thermoforming of the brand names, logo, trademarks, or other identifiers on the surface of the collar 200, 200-1, 200-2 or for knurling the exterior surface.

While press fitting the collar 200, 200-1, 200-2 onto the shafts 14-1, 14-2, 102 is one method of securing the collar 200 or collars 200-1, 200-2, 200 to the shafts 14, 14-1, 14-2, 102, thermoforming or injection molding the collar 200 or collars 200-1, 200-2 onto the shafts 14, 14-1, 14-2, 102 may be equally suitable. Additionally or alternatively, the collar 200, 200-1, 200-2 may be bonded to the shafts 14, 14-1, 14-2, 102 such as by welding or an adhesive. Additionally or alternatively, the collar 200, 200-1, 200-2, 200 may be formed integral with the shafts 14, 14-1, 14-2, 102 during original manufacturing of the shafts 14, 14-1, 14-2 or shaft 102. Additionally, it should also be appreciated that although the outer periphery of the shafts 14, 14-1, 14-2, 102, and the locking members 22-1, 22-2, 122-1, 122-2 and the collar 200 or collars 200-1, 200-2 are illustrated as being cylindrical, the outer peripheries of any of those components may be any desirable shape.

Based on the foregoing, it should be appreciated that any of the embodiments of the double-ended quick-change tool bit holder assembly 100A, 100B, 100C, 100D as described above will avoid the need for consumers to purchase separate quick-change bit drivers 10A, 10B, 10C, 10D if the consumer desires a longer or shorter drive shank. Instead, the consumer can simply purchase bar stock complimentary in size and configuration to the tool bit socket 32-1, 132-1 (such as, for example, ¼ inch hex bar stock) and cut the bar stock to the desired length for use as the driver shank 70 at a fraction of the cost compared to purchasing a separate quick-change bit driver with a shank of the desired length (assuming the desired shank length is available). The consumer may form the circumferential depression 73 proximate one end of the bar stock after being cut to length so that the fabricated driver shank 70 cooperates with the locking member 22-1, 122-1 at the first end of the double-ended quick-change tool bit holder assembly 100A, 100B, 100C, 100D as previously described. In some embodiments, however, the circumferential depression 73 may be unnecessary for the bar stock to be retained in the socket 32-1, 32-2, 132-1, 132-2. The second end of the double-ended quick-change tool bit holder assembly 100A, 100B, 100C, 100D would function the same as the OEM quick-change bit driver 10A, 10B, 10C, 10D from which the double-ended quick-change tool bit holder assembly 100A, 100B, 100C, 100D was constructed or to which the double-ended quick-change tool bit holder assembly 100A, 100B, 100C, 100D was fabricated to emulate under the alternative forms of assembly described above.

Furthermore, it should be appreciated that although various patent references and specific OEMs and/or brand names of commercially available quick-change bit drivers and quick-change reversible drill/drivers were referenced in the foregoing description, there are numerous other quick-change bit drivers and quick-change reversible drill/drivers that may be disclosed in patents and/or commercially available to which the features and functionality disclosed herein could be applied or adapted. Thus, the foregoing description and appended claims are not to be limited to any of the referenced OEM quick-change bit drivers and quick-change reversible drill/drivers or brand names or disclosed patents. Nor are the double-ended quick-change tool bit holder assemblies 100A, 100B, 100C, 100D described herein limited to any particular type of locking member or mechanism or to the direction of movement of the locking member or mechanism. Rather, the referenced patents, and the referenced OEM quick-change bit drivers and quick-change reversible drill/drivers and brand names, as well as the foregoing description and drawings are intended to be illustrative and not restrictive. Various modifications to the embodiments and to the general principles, features and methods to produce and/or fabricate the double-ended quick-change tool bit holder assemblies and for modifying the quick-change bit drivers disclosed or referenced herein will be apparent to those of ordinary skill in the art. Thus, the disclosure should be accorded the widest scope consistent with the appended claims and the full scope of the equivalents to which such claims are entitled.

1. A double-ended quick-change tool bit holder assembly, comprising:
a shaft having a first end and a second end;
a first tool bit socket at the first end of the shaft, the first tool bit socket configured to receive a proximal end of complimentary configured driver shank, a distal end of the driver shank adapted to be received in a chuck of a power tool;
a second tool bit socket at the second end of the shaft, the second tool bit socket configured to receive a complimentary tool bit;
a first locking member disposed over the first end of the shaft, the first locking member movable between a release position and a lock position, wherein in the lock position the first locking member cooperates with the first tool bit socket to securely lock the proximal end of the complimentary configured driver shank within the first tool bit socket, wherein in the release position the first locking member cooperates with the first tool bit socket to release the proximal end of the driver shank from the first tool bit socket;
a second locking member disposed over the second end of the shaft, the second locking member movable between a release position and a lock position, wherein in the lock position the second locking member cooperates with the second tool bit socket to securely lock the complimentary tool bit within the second tool bit socket, wherein in the release position the second locking member cooperates with the second tool bit socket to release the tool bit from the second tool bit socket.

2. The double-ended quick-change tool bit holder assembly of claim 1, wherein the tool bit is selected from the group consisting of a reversible drill/driver, a slotted driver, crosshead driver, a star head driver, hex head driver, a square head, and a socket driver.

3. The double-ended quick-change tool bit holder assembly of claim 1, further comprising at least one collar disposed over the shaft between the first locking member and the second locking member.

4. The double-ended quick-change tool bit holder assembly of claim 3, wherein the at least one collar includes a first collar and a second collar, the first collar positioned on the shaft to abut an inward end of the first locking member when in the locked position, the second collar positioned on the shaft to abut an inward end of the second locking member when in the locked position.

5. The double-ended quick-change tool bit holder assembly of claim 3, wherein the at least one collar is an elongated collar having a length such that one end of the elongated collar abuts an inward end of the first locking member when in the locked position and such that a second end of the elongated collar abuts an inward end of the second locking member when in the locked position.

6. The double-ended quick-change tool bit holder assembly of claim 3, wherein the at least one the collar is press fit onto the shaft.

7. The double-ended quick-change tool bit holder assembly of claim 4, wherein the first collar and the second collar are each press fit onto the shaft.

8. The double-ended quick-change tool bit holder assembly of claim 3, wherein the at least one collar is fixed to the shaft.

9. The double-ended quick-change tool bit holder assembly of claim 3, wherein the at least one collar is formed integral with the shaft.

10. The double-ended quick-change tool bit holder assembly of claim 3, wherein at least one collar consists of Delrin® plastic.

11. The double-ended quick-change tool bit holder assembly of claim 3, wherein an exterior surface of the at least one collar includes an identifier.

12. The double-ended quick-change tool bit holder assembly of claim 3, wherein an exterior surface of the least one collar is knurled.

13. The double-ended quick-change tool bit holder assembly of claim 1 produced by the steps comprising:
selecting a first quick-change bit driver, the first quick-change bit driver including a shaft member to which a drive shank is fixed at a first end thereof, and further including a second end having a tool bit socket and a locking member;
selecting a second quick-change bit driver, the second quick-change bit driver including a shaft member to which a drive shank is fixed at a first end thereof, and further including a second end having a tool bit socket and a locking member;
removing the drive shank from the first end of the shaft member of the first quick-change bit driver;
removing the drive shank from the first end of the shaft member of the second quick-change bit driver;
rigidly fixing end-to-end the first end of the shaft member of the first quick-change bit driver to the first end of the shaft member of the second quick-change bit driver;
wherein the shaft members of the first and second quick-change bit drivers rigidly fixed end-to-end is the shaft of the double-ended quick-change tool bit holder assembly, and
wherein the tool bit socket of the first quick-change bit driver is the first tool bit socket of the double-ended quick-change tool bit holder assembly;
wherein the locking member of the first quick-change bit driver is the first locking member of the double-ended quick-change tool bit holder assembly;
wherein the tool bit socket of the second quick-change bit driver is the second tool bit socket of the double-ended quick-change tool bit holder assembly; and
wherein the locking member of the second quick-change bit driver is the second locking member of the double-ended quick-change tool bit holder assembly.

14. The double-ended quick-change tool bit holder assembly of claim 13 produced by the steps further comprising:
disposing a collar on the shaft between the first and second locking members.

15. A quick-change bit driver, comprising:
a shaft having a first end and a second end;
a drive shank fixed at the first end of the shaft;
a tool bit socket at a second end of the shaft
a locking member disposed over the second end of the shaft, the locking member movable between a release position and a lock position, wherein in the lock position, the locking member cooperates with the tool bit socket to securely lock a complimentary tool bit within the tool bit socket, and wherein in the release position, the locking member cooperates with the tool bit socket to release the complimentary tool bit from the tool bit socket;
an elongated collar disposed on the shaft, the elongated collar having a length proximate the length of the shaft without obstructing the locking member when in the release position or lock position, the elongated collar including an identifier on an exterior surface thereof.
